(19) United States
(12) Patent Application Publication
(10) Pub. No.: US 2005/0044997 A1
(43) Pub. Date: Mar. 3, 2005

(54) High torsional force structure for a ratchet device

(76) Inventor: Ling Lang Liu, Taipei (TW)

Correspondence Address: Ling Lang Liu, PO Box 82-144, Taipei, TW

(21) Appl. No.: 10/647,175

(22) Filed: Aug. 25, 2003

(51) Int. Cl. B25B 13/46

(52) U.S. Cl. 81/63.2; 192/43.2

(57) ABSTRACT

A high torsional force structure for a ratchet device is disclosed. The structure comprises a head portion at one end of the body of the structure and the head portion having a cavity and a ratchet block slot having corresponding tool head and ratchet block with ratchet teeth and the ratchet block engaged with the tool head and the tool head being free to rotate, characterized in that the external edge of the tool head is provided with rows of ratchet teeth and one lateral edge of the ratchet block is formed with ratchet teeth corresponding to the ratchet teeth of the tool head, and the two ends of the ratchet blocks are respectively protruded out with an engaging portion of conic shape, and the two engaging portions are adapted for an inclined space formed by the two lateral sides of the tool head and the ratchet slots, and when any side of the ratchet block engages with the tool head, the lateral edge at the rear side of the engaging portion fully adhered onto the corresponding face of the ratchet slot, and when the tool head rotates, the engaging portion of the ratchet block is tightened by the inclined space.

### BACKGROUND OF THE INVENTION

(a) Technical Field of the Invention

The present invention relates to the improvement of torsional force of a ratchet device.

(b) Brief Description of the Prior Art

FIGS. 1A and 1B disclose Taiwanese Patent Publication No. 483365 entitled “High Torsional Force Wrench” which includes a wrench body 10 having a head portion 11 center provided with a cavity 12. At the proximity of the wrench body 10, a deeper cavity slot 15 is provided and the cavity 12 is adaptable for the ratchet wheel 20 having ratchet teeth 21. The inner side of the cavity slot 15 is provided for the ratchet teeth block 25 with corresponding ratchet teeth 26. An urging structure 28 within the wrench body 10 is used to engage with the ratchet wheel 20. The two sides of the wrench body 10 corresponding to the cavity slot 15 are provided with two control elements 18 for the control of the direction of the ratchet wheel 20 of the ratchet block 25.

The drawbacks of the conventional ratchet wheel of the ratchet wrench are that there is a displacement between the engaging teeth of the ratchet teeth and the ratchet block 25 will be pushed outward. This will damage the control element 18 and the ratchet wrench cannot function properly. In worse case, this drawback is very significant in small ratchet wrenches.

In view of the above, it is an object of the present invention to provide a high torsional force structure for a ratchet device, which mitigates the above drawbacks.

### SUMMARY OF THE INVENTION

Accordingly, it is an object of the present invention to provide a high torsional force structure for a ratchet device having a head portion at one end of the body of the structure and the head portion having a cavity and a ratchet block slot having corresponding tool head and ratchet block with ratchet teeth and the ratchet block engaged with the tool head and the tool head being free to rotate, characterized in that the external edge of the tool head is provided with rows of ratchet teeth and one lateral edge of the ratchet block is formed with ratchet teeth corresponding to the ratchet teeth of the tool head, and the two ends of the ratchet blocks are respectively protruded out with an engaging portion of conic shape, and the two engaging portions are adapted for an inclined space formed by the two lateral sides of the tool head and the ratchet slots, and when any side of the ratchet block engages with the tool head, the lateral edge at the rear side of the engaging portion fully adhered onto the corresponding face of the ratchet slot, and when the tool head rotates, the engaging portion of the ratchet block is tightened by the inclined space.

Yet another object of the present invention is to provide a high torsional force structure for a ratchet device, wherein the anti-twisting force of the ratchet device is improved, and the slips between the teeth of the ratchet blocks are eliminated, the longevity of the ratchet device is prolonged and the cost of production is low.

Still another object of the present invention is to provide a high torsional force structure for a ratchet device, wherein the operation and control of the ratchet device is simple and convenient.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A and 1B are schematic views of a conventional ratchet wrench.

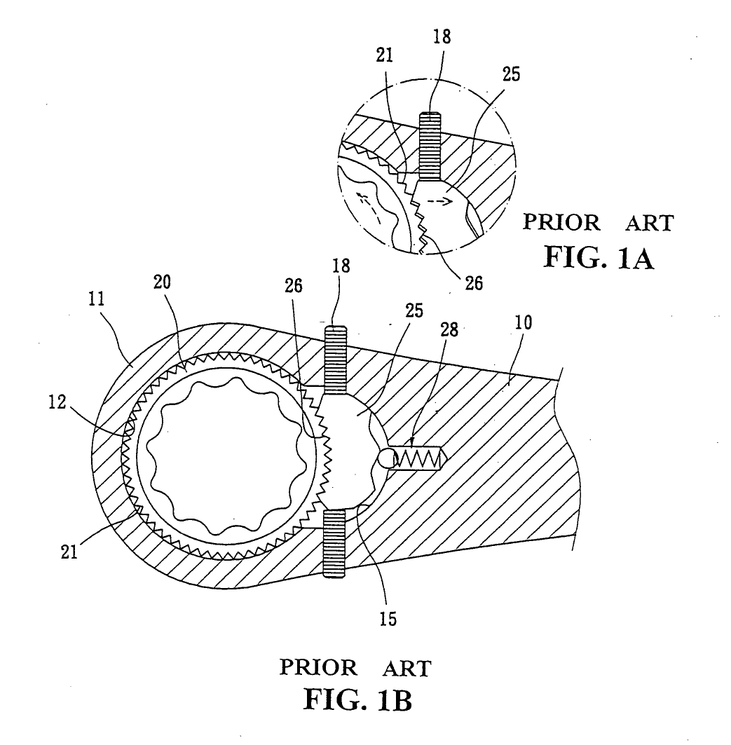

FIG. 2 is a perspective exploded view of the torsional force structure of ratchet device of the present invention.

FIG. 3 is a schematic view showing the ratchet device of the present invention.

FIG. 4 is another schematic view of the ratchet device of the present invention.

FIG. 5 is a perspective exploded view of another preferred embodiment of the present invention.

FIG. 6 is a schematic view of the ratchet device of the present invention.

FIG. 7 is a perspective exploded view of another preferred embodiment of the present invention.

FIG. 8 is another schematic view of the ratchet device in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

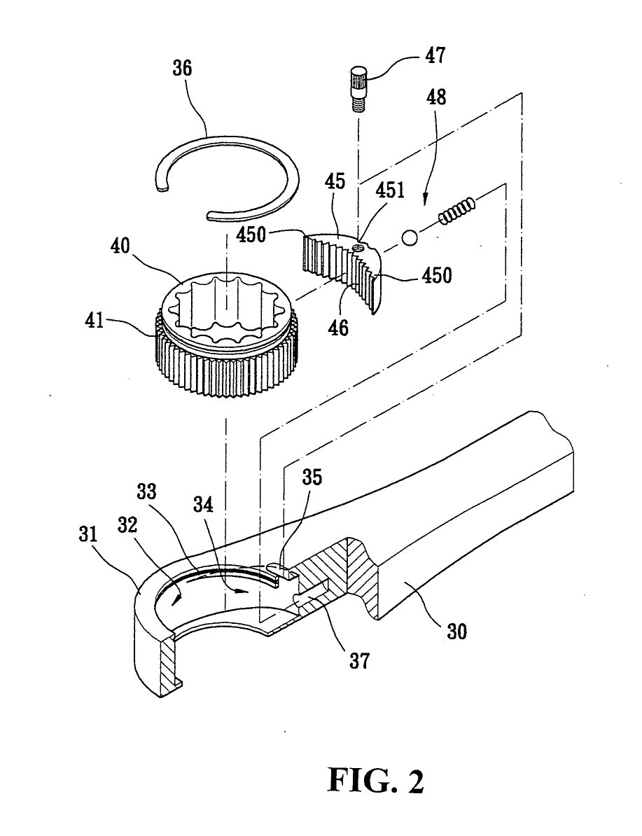

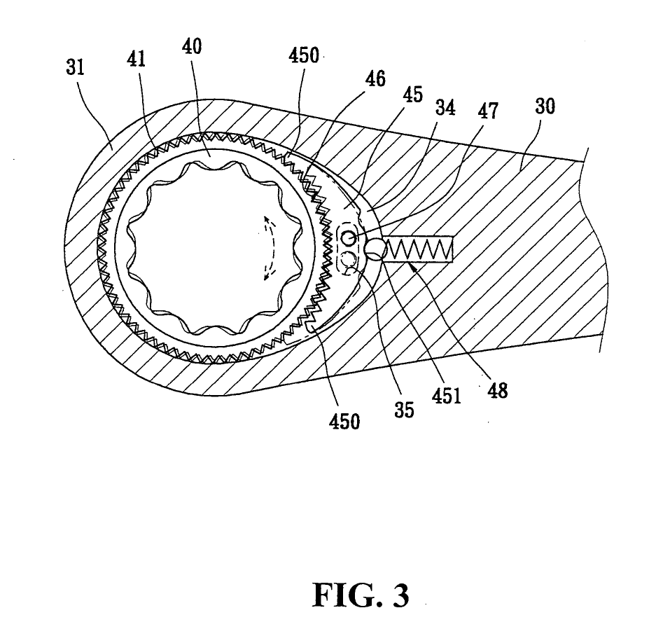

Referring to FIGS. 2 and 3, there is shown a ratchet device of a ratchet wrench having a body 30 with a larger head portion 31 at the end section of the body 30. The head portion 31 is adaptable for a tool head 40 and a ratchet block 45 and the ratchet block 40 is used to control the free rotating of and engaging direction of the tool head 40.

The head portion 31 is provided with a cavity 32 and at the proximity of the upper edge of the cavity 32, a rim-fastening slot 33 is formed at the inner face thereof A C-shaped fastener 36 is used to limit the tool head 40. The tool head 40 at the proximity of one side of the body 30, a ratchet block slot 34 in communication with the cavity 32 is formed, and the inner edge of the ratchet block slot 34 and the two sides of the cavity 32 are in tangential direction for the holding of a triggering slot 35. A holding hole 37 is formed at the inner face of the ratchet block slot 34 of the body 30.

The external edge of the tool head 40 is a plurality rows of ratchet teeth 41 and one side of the ratchet block 45 is formed with ratchet teeth 46 corresponding to the ratchet teeth 41 of the tool head 40. The two ends of the ratchet block 45 are respectively protruded out with a conic shape engaging portion 450. The two engaging portion 450 can be fully placed into the inclined space between the two lateral sides of the ratchet block slot 34 and the tool head 40, and when ratchet block 45 is facing any side to engage the tool head, the ratchet teeth 46 corresponding to the engaging portion 450 can be fully in engagement with the ratchet teeth 41 of the tool head 40, and the read face lateral edge of the engaging portion 450 can fully urge the corresponding inner face of the ratchet block slot 34, and when the tool head 40 rotates more, the engaging portion 450 of the ratchet block 45 is tightened by the inclined space, and the center of the rear face of the ratchet block 45 is provided with wavelike positioning engaging edge 451.

The top face of the ratchet block 45 is provided with a triggering rod 47 passing through the triggering slot 35 of the body 30 to control the displacement of the ratchet block 45, and the cavity hole 37 of the body 30 is provided with an elastic urging structure 48, and the urging structure 48 is appropriately urging the positioning engaging edge 451 of the ratchet block 45 for the positioning of the triggered ratchet block 45.

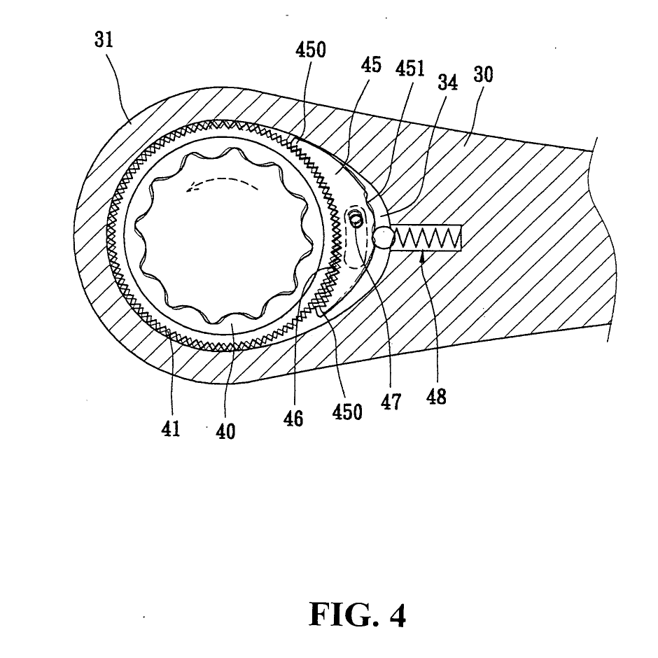

In operation, as shown in FIGS. 3 and 4, after the ratchet device is positioned at one side of the tool head 40 of the ratchet block 45, the engaging portion 450 can appropriately engage with the inclined space between the tool head and the ratchet block slot 34, the ratchet block 45 corresponding to the ratchet teeth 46 of the engaging portion 450 can fully engage with the ratchet teeth 41 and the rear face of the engaging portion 450 can fully urge the corresponding inner face of the ratchet slot 34, and the twisting force of the ratchet block 45 can be evenly distributed to the engaged ratchet teeth 46 and the rear edge and therefore the resistance to twisting force is improved. The conic shape design of the engaging portion 450 allows the engaging portion 450 to be tightened when the tool head 40 rotates. This will fully eliminate the gaps of the ratchet teeth 41,46 so as to avoid the over-run of the teeth and therefore the longevity of the ratchet device is prolonged. The twisting force is absorbed by the ratchet block 45 and eliminates the tension of the triggering rod 47.

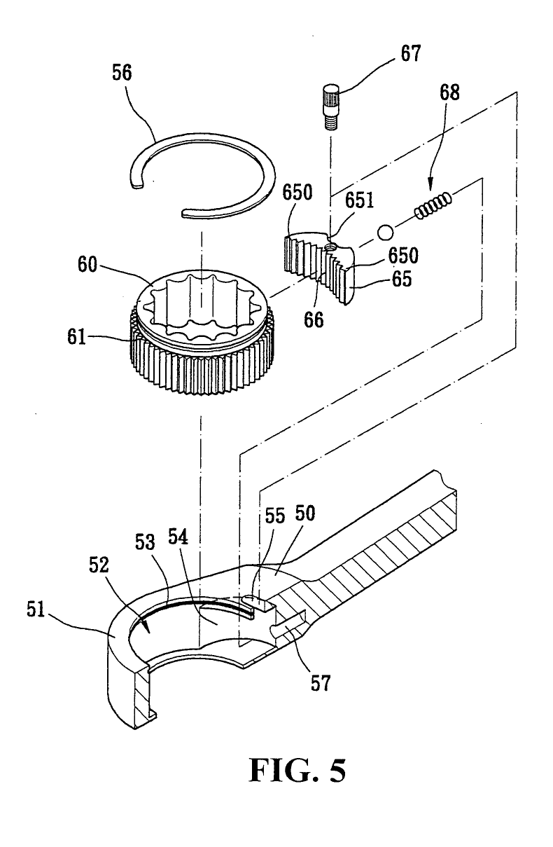

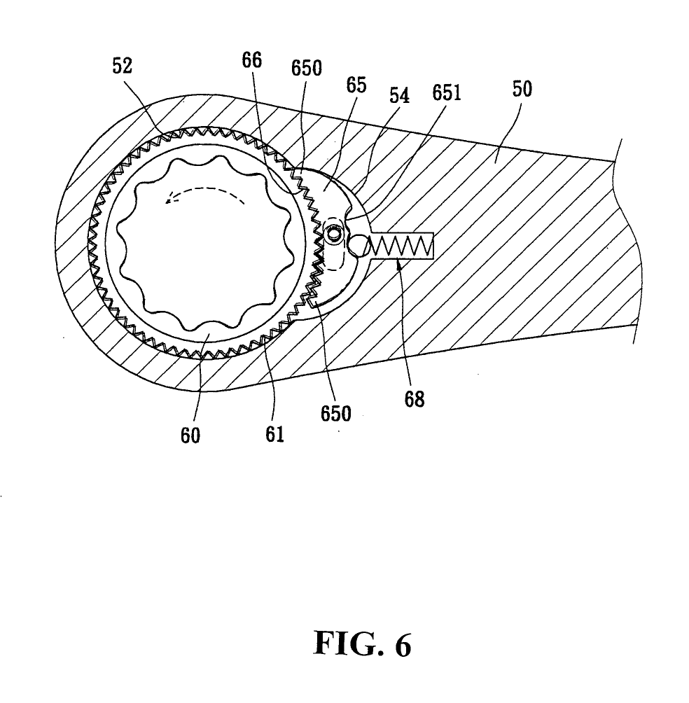

FIGS. 5 and 6 show another preferred embodiment of the present invention. The end portion of the body 50 is a head portion 51 and the top of the head portion 51 is a cavity 52 with a rim-fastening slot 53 for the mounting of the tool head 60 and a c-shaped fastener 56 is used for restriction. One side of the cavity 52 is a ratchet block slot 54, which is in communication with each other, and the slot 54 is a recess so as to increase the thickness of the ratchet block 65. The top face of the body 50 corresponding to the ratchet block slot 54 is a triggering slot 55 and the ratchet block slot 54 is a cavity hole 57.

The external edge of the tool head 60 is provided with a plurality of ratchet teeth 61 and one side of the ratchet block 65 is provided with ratchet teeth 66 and the two ends of the ratchet block 65 are respectively protruded with conic shaped engaging portion 650, and the engaging portion 650 can be fully positioned within the inclined space formed by the tool head and the ratchet block slot 54. The rear face of the ratchet block 65 is wavelike positioning engaging edge 651, and the top face of the ratchet block 65 is provided with a triggering rod 67 passing through the triggering hole 55. The cavity hole 57 of the body 50 is an elastic urging structure 68 which can urge the positioning engaging edge 651 of the ratchet block 65 and thus a high torsional structure for a ratchet device is obtained.

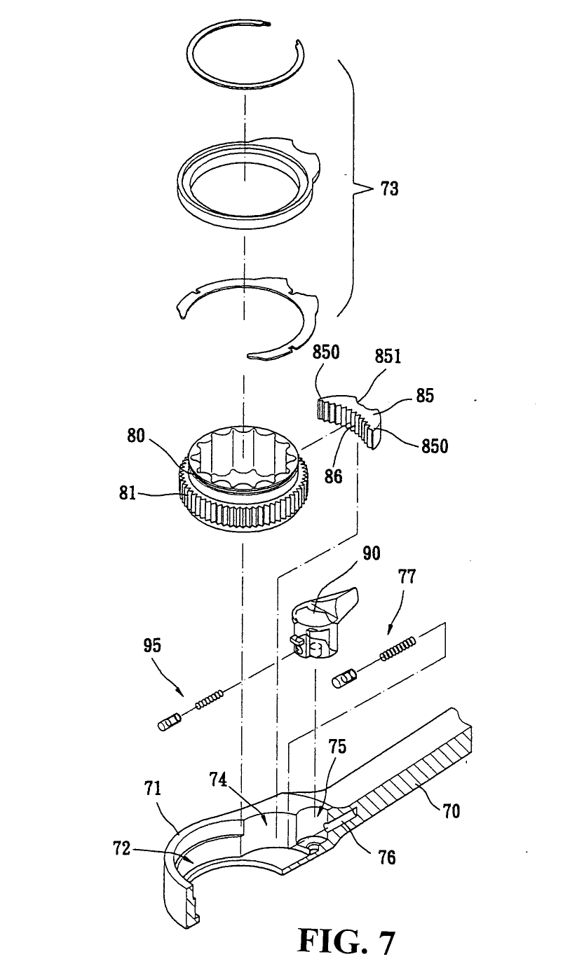

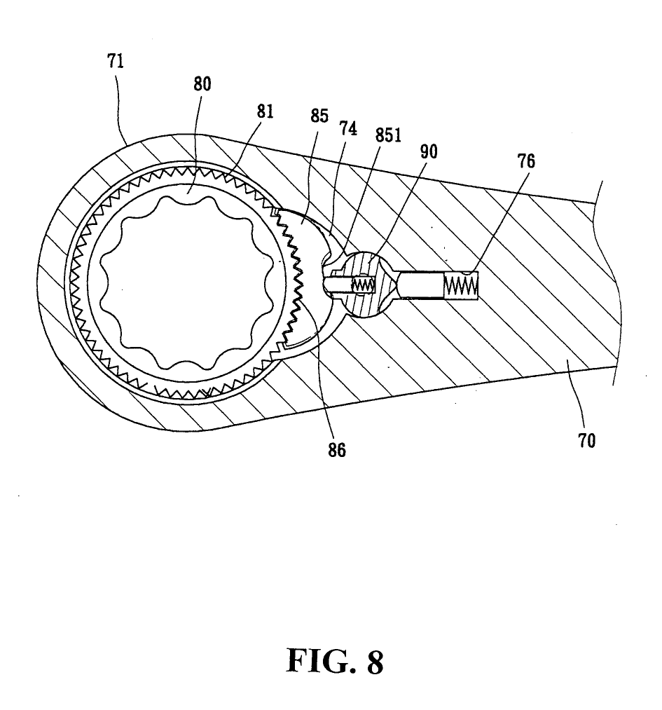

FIGS. 7 and 8 are another preferred embodiments in accordance with the present invention. The top portion of the body 70 has a head portion 71 having a cavity 72 for holding a tool head 80. The top face of the cavity 72 employs a rim fastener 73 to restrict the tool head 80, and one side of the cavity is a ratchet block slot 74 and the lateral edge of the cavity 72 is a triggering slot 75 for pivotally mounting of a triggering rod 90. A cavity hole 76 is formed at the inner face of the triggering slot 75 and a positioning structure 77 for urging the triggering rod 90 is provided at the cavity 76 for the limitation of the triggering rod 90.

The external edge of the tool head 80 is a plurality of ratchet teeth 81 and one side of the ratchet block 85 is provided with ratchet teeth 86 and the two end of the ratchet block 85 are protruded out with a conic shaped engaging portion 850. The two engaging portion 850 can fully be mounted to the inclined space formed between the tool head 85 and the two sides of the ratchet block slot 74. The rear face of the ratchet block 85 is provided with positioning engaging edge 851, and the triggering rod 90 corresponding to the circumferential edge of the ratchet block is provided with the urging structure 95 so that the ratchet block 85 is positioned by the triggering rod 90, and a high torsional force structure is obtained.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A high torsional force structure for a ratchet device having a head portion at one end of the body of the structure and the head portion having a cavity and a ratchet block slot having corresponding tool head and ratchet block with ratchet teeth and the ratchet block engaged with the tool head and the tool head being free to rotate, characterized in that the external edge of the tool head is provided with rows of ratchet teeth and one lateral edge of the ratchet block is formed with ratchet teeth corresponding to the ratchet teeth of the tool head, and the two ends of the ratchet blocks are respectively protruded out with an engaging portion of conic shape, and the two engaging portions are adapted for an inclined space formed by the two lateral sides of the tool head and the ratchet slots, and when any side of the ratchet block engages with the tool head, the lateral edge at the rear side of the engaging portion fully adhered onto the corresponding face of the ratchet slot, and when the tool head rotates, the engaging portion of the ratchet block is tightened by the inclined space.
